(19) United States
(12) Patent Application Publication
(10) Pub. No.: US 2013/0340033 A1
(43) Pub. Date: Dec. 19, 2013

(54) APPARATUS, METHODS AND MEDIA FOR LOCATION BASED DATA ACCESS POLICIES

(71) Applicant: AppSense Limited, Warrington (GB)

(72) Inventors: Peter Thomas JONES, Cheshire (GB); Darren Robert BOYCE, Cheshire (GB)

(21) Appl. No.: 13/919,679

(22) Filed: Jun. 17, 2013

(30) Foreign Application Priority Data
Jun. 19, 2012 (GB) GB1210845.2

(51) Int. Cl. H04W 12/08

(52) U.S. Cl. CPC H04W 12/08
USPC 726/1

(57) ABSTRACT

A method of administering an application management policy is provided. The method includes determining, in response to a request for access to a service, whether the first device is known. The service is provided by an application running on the server. The method also includes determining whether the first device is capable of providing location information. The method further includes, when it is determined that the first device is incapable of providing the location information, determining whether the first device is in communication with a second device capable of providing second location information. The first and second devices are in close proximity that the second location information can be used as a proxy for the first location information. The method also includes determining the physical location of the first device using the second location information. The method further includes setting the policy based on the physical location of the first device.

### RELATED APPLICATION

This application claims the benefit of the earliest filing date of U.K. Patent Application No. GB1210845.2, filed on Jun. 19, 2012, which is hereby incorporated by reference herein in its entirety.

### TECHNICAL FIELD

The present application relates to administration of application management policy based on physical location of mobile devices.

### BACKGROUND

The present invention concerns the provision of controlled access to computer or other networked resources. Embodiments of the invention find particular, but not exclusive use, in the area known as Bring Your Own Device (BYOD). This is related to the growing phenomenon of staff(s) using their own computing device(s) for work-related activities.

It is now relatively common for employees to work on their employer's business using their own devices. Such devices can include portable devices such as laptop computers, netbook computers, tablet computers (e.g., the Apple® iPad®) and smartphones. However, although use of such devices can be convenient to both the employee and the employer, their use can create security vulnerabilities, since the employer is not in ultimate control of the devices and is unable to fully implement security and access policies.

### SUMMARY

It is an aim of embodiments of the present invention to permit the application of a security and access policy, which takes into account a number of different conditions and to allow or refuse access to certain applications on the basis of the evaluation of these conditions.

According to the present invention there is provided an apparatus, methods and media as set forth in the appended claims. Other features of the invention will be apparent from the dependent claims, and the description which follows.

According to one embodiment of the present invention, there is provided a method of administering an application management policy. The method includes determining, in response to a request made by a first mobile device for access to a service provided over a wireless network, whether the first mobile device is known to a server. The service is provided by one of a plurality of application programs running on the server and the first mobile device is owned and operated by a user. The method also includes determining whether the first device is capable of providing first location information to the server when the first mobile device is identified to be known to the server. The first location information can be used by the server to determine physical location of the first mobile device.

The method further includes determining whether the first mobile device is in communication with a second mobile device capable of providing second location information, which can be used to determine physical location of the second mobile device, when it is determined that the first mobile device is incapable of providing the first location information. The second mobile device is owned and operated by the user. The first mobile device and the second mobile device are in close physical proximity such that the second location information can be used as a proxy for the first location information. The first mobile device and the second mobile device are in communication via a communication link.

The method also includes determining the physical location of the first mobile device using the second location information provided by the second mobile device when it is determined that the first mobile device is in communication with the second mobile device. The method further includes setting the application management policy. The application management policy is configured to grant or deny the first mobile device access to one or more of the plurality of application programs based on the physical location and identity of the first mobile device.

In another embodiment, there is provided an apparatus that includes a memory capable of storing data and a processor. The processor is configured for using the data such that the apparatus determines, in response to a request made by a first mobile device for access to a service provided over a wireless network, whether the first mobile device is known to the apparatus. The service is provided by one of a plurality of application programs running on the apparatus and the first mobile device is owned and operated by a user. The processor is also configured for using the data such that the apparatus determines whether the first device is capable of providing first location information to the apparatus when the first mobile device is identified to be known to the apparatus. The first location information can be used by the apparatus to determine physical location of the first mobile device.

The processor is further configured for using the data such that the apparatus determines whether the first mobile device is in communication with a second mobile device capable of providing second location information, which can be used to determine physical location of the second mobile device, when it is determined that the first mobile device is incapable of providing the first location information. The second mobile device is owned and operated by the user. The first mobile device and the second mobile device are in close physical proximity such that the second location information can be used as a proxy for the first location information. The first mobile device and the second mobile device are in communication via a communication link.

The processor is also configured for using the data such that the apparatus determines the physical location of the first mobile device using the second location information provided by the second mobile device when it is determined that the first mobile device is in communication with the second mobile device. The processor is further configured for using the data such that the apparatus sets the application management policy. The application management policy is configured to grant or deny the first mobile device access to one or more of the plurality of application programs based on the physical location and identity of the first mobile device.

In yet another embodiment, there is provided a non-transitory computer readable medium having executable instructions operable to cause an apparatus to determine, in response to a request made by a first mobile device for access to a service provided over a wireless network, whether the first mobile device is known to a server. The service is provided by one of a plurality of application programs running on the server and the first mobile device is owned and operated by a user. The executable instructions are also operable to cause the apparatus to determine whether the first device is capable of providing first location information to the server when the first mobile device is identified to be known to the server. The first location information can be used by the server to determine physical location of the first mobile device.

The executable instructions are further operable to cause the apparatus to determine whether the first mobile device is in communication with a second mobile device capable of providing second location information, which can be used to determine physical location of the second mobile device, when it is determined that the first mobile device is incapable of providing the first location information. The second mobile device is owned and operated by the user. The first mobile device and the second mobile device are in close physical proximity such that the second location information can be used as a proxy for the first location information. The first mobile device and the second mobile device are in communication via a communication link.

The executable instructions are also operable to cause the apparatus to determine the physical location of the first mobile device using the second location information provided by the second mobile device when it is determined that the first mobile device is in communication with the second mobile device. The executable instructions are further operable to cause the apparatus to set the application management policy. The application management policy is configured to grant or deny the first mobile device access to one or more of the plurality of application programs based on the physical location and identity of the first mobile device.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 shows a method of administering an application management policy in accordance with an embodiment of the disclosed subject matter;

FIG. 2 shows a method of administering an application management policy in accordance with an embodiment of the disclosed subject matter;

FIG. 3 shows further details relating to the method shown in FIG. 2 in accordance with an embodiment of the disclosed subject matter;

FIG. 4 shows a schematic of a first mobile device communicating with a remote server in accordance with an embodiment of the disclosed subject matter;

FIG. 5 shows a schematic of the first mobile device communicating with the remote server, and also with a further remote device in accordance with an embodiment of the disclosed subject matter;

FIG. 6 shows a schematic of the first mobile device, in communication with a second mobile device and two remote servers in accordance with an embodiment of the disclosed subject matter; and

FIG. 7 shows an apparatus configured to perform embodiments of the disclosed subject matter.

### DETAILED DESCRIPTION

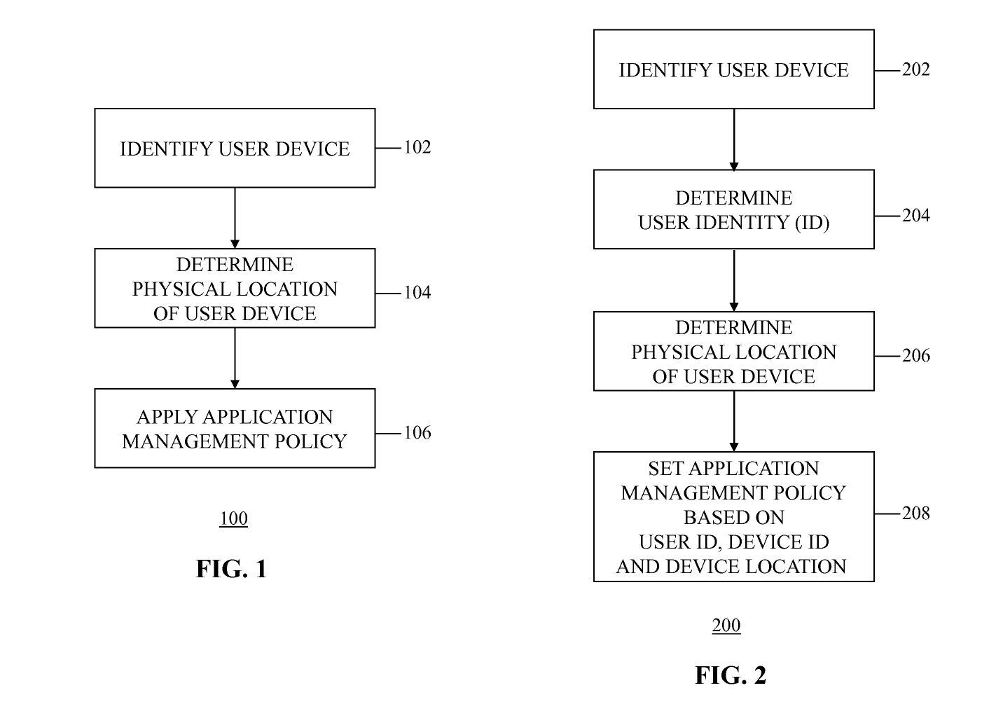

FIG. 1 shows a method 100 of administering an application management policy in accordance with an embodiment of the disclosed subject matter. A user is in possession of a device for accessing a remote network. The device may be any form of computing device as set out earlier. In the following description, attention will be focussed on a portable computing device such as a laptop computer or tablet computer, but this is not intended to be limiting.

The application management policy is a process which runs on a computer system to which remote users may seek access. Corporations often use applications to allow access to business critical data. Users can access these running applications directly or via Virtual Desktop Infrastructure (VDI) or Remote Desktop Services (RDS) sessions from almost any device anywhere, provided a suitable network connection is available. This may present a problem to corporations in terms of control and security of their business information when users use these applications on mobile devices, since the data maybe more susceptible to being compromised by technological means—e.g., packet sniffing. Also, simple visual interception (known as shoulder surfing) can be a problem, whereby sensitive data can simply be observed by third parties on the screen of the user's device.

At 102, a user device is identified, upon which a user instance of a particular application is running. At 104, the physical location of the user device is determined At 106, an application management policy is applied in accordance with the identification of the user device and its physical location.

To further understand this, FIG. 2 shows a further embodiment 200, which is an addition to the method already set out above. The embodiment of FIG. 2 looks to determine the identity of the user device at 202 (i.e., is it a device which is known to the system?). A determination is also made of the identity of the user at 204.

At 206, the physical location of the user device is determined This is done to ensure that the device is operating in a known location which has been pre-determined to be secure.

Then, the application management policy is applied at 208 based on the identification of the user device, its location and the identification of the user.

To illustrate this, a user may use his portable device to access a corporate system from his desk using a Wi-Fi access point (AP). The Wi-Fi signal may also be accessible from the coffee shop next door to his office and the user would like to continue working from that location whilst taking a break. However, the data on his screen is vulnerable and may be intercepted. As such, even though the user is known and trusted, the particular physical location means that he is vulnerable and so the application management policy can restrict his access to all or some applications. For instance, if the user is a financial trader, access to financial trading systems could be restricted, so that they can only be accessed and operated from within a physical location which is known to be the corporate office.

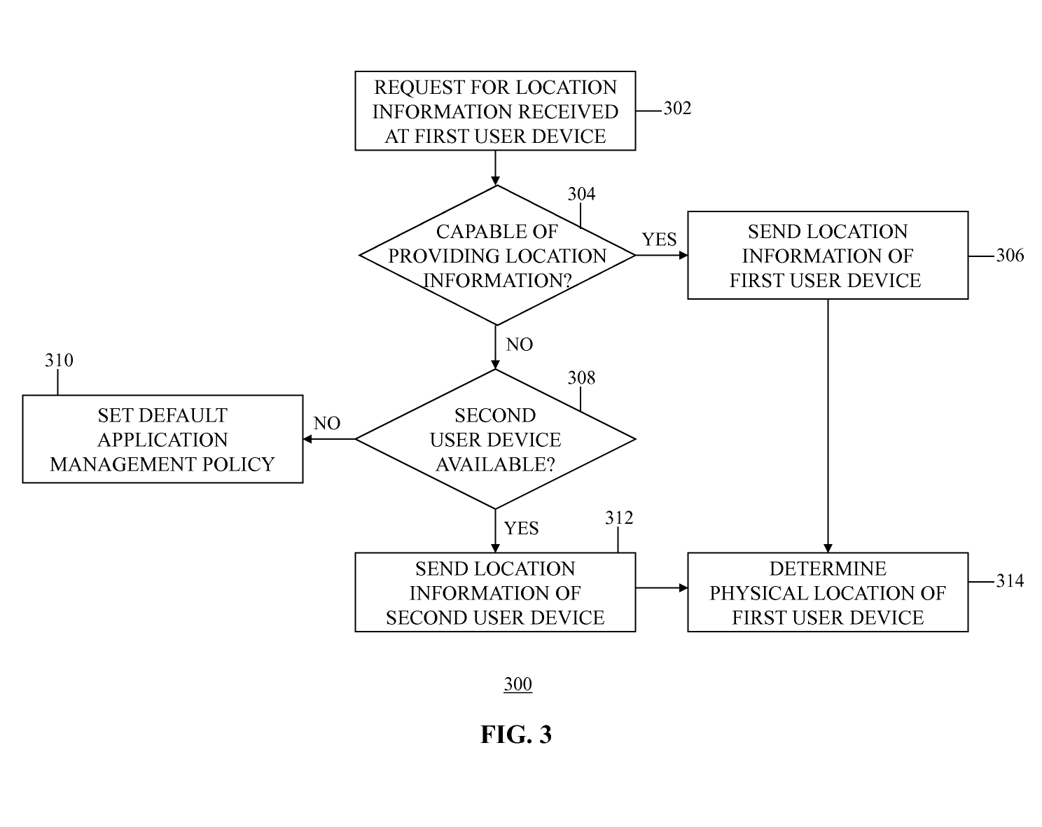

FIG. 3 shows further detail 300 about the step 104 where the physical location of the user device is determined. At 302, a request is made of the user device to respond with its location. For example, a request for location information/data is received at a first user device. Not all portable user devices are suitably equipped to respond with location data. For instance, some tablet computers are provided with GPS functionality, which enable them to determine their location with a given degree of accuracy, whereas many laptop computers lack this feature. However, in the absence of such functionality, the remote device may not be able to respond with a meaningful location response.

At 304, a determination is made whether the first user device is capable of providing location data/information. If it is, then the location data is sent to the remote server at 306 and the location data is used to determine the physical location of the first user device at 314. If, however, the first user device is not capable of providing location data, then a determination is made at 308 whether there is a second user device, in communication with the first user device, that is capable of providing location data.

To illustrate this, if the first user device is a laptop computer without GPS functionality, then it will not be able to respond to a request for location information and so the application management policy will bar access to certain applications as a result. However, as is increasingly common, the user of the laptop computer is likely to have his personal smartphone, which is more likely to be provided with GPS functionality. A feature of an embodiment of the present invention is to use the location of the second user device as a proxy for the location of the first user device. This can be achieved by creating a communication link between the first and second user devices, ensuring that they are in close physical proximity. This ensures that the assumption that they are in the same location is always true.

If it is determined at 308 that a second user device is not available, a default application management policy is set at 310. In one embodiment, the default setting of the application management policy denies access to some or all applications as a failsafe measure under such a circumstance. If, however, it is determined at 308 that a second user device capable of providing location information/data is available, the location information of the second user device is sent at 312 as a proxy for the location information of the first user device. At 314, the location information sent from the second user device is used to determine the physical location of the first user device.

In one embodiment, the communication link between the two user devices can be established using a physical connection, such as a data cable connecting the two devices. Alternatively, and in a preferred embodiment, a Low Power RF (LPRF) wireless connection is created between the two devices. An example of such a connection uses the Bluetooth protocol.

In one embodiment, if a location request is made of the first user device, it then passes the request to the second user device after first establishing a communication link therewith if one is not already setup. The second device replies to the first device with the location information, which is then relayed to the remote server and the application management policy is applied accordingly.

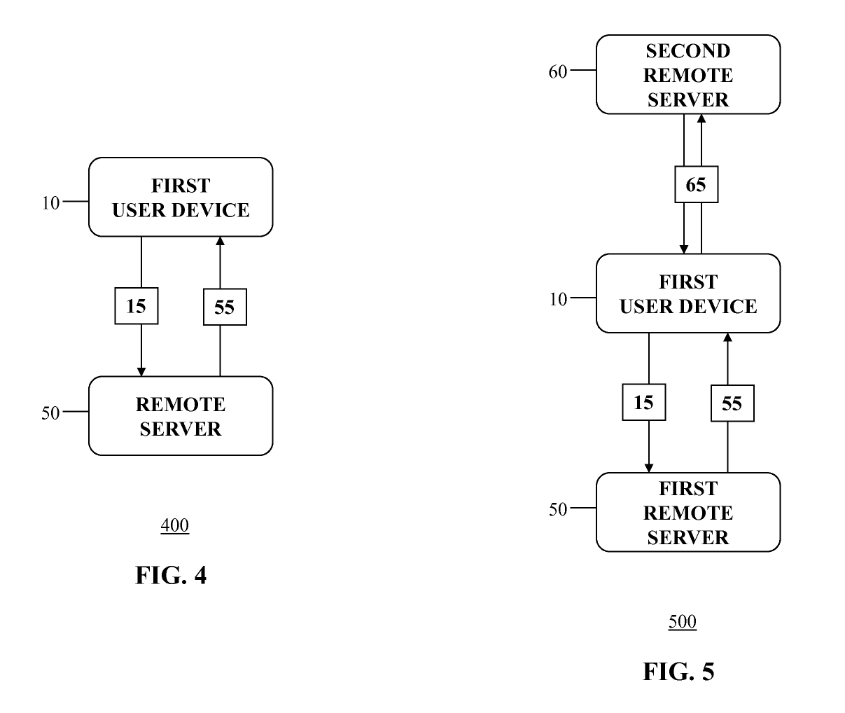

FIG. 4 shows a schematic 400 of the first user device 10 in communication with a remote server 50. The communication is typically conducted over a local Wi-Fi connection and the internet. On receipt of the location data 15, the server 50 responds with an application management policy 55. In one embodiment, the application management policy 55 is interpreted at the first device 10 so as to allow or deny access to one or more applications which may run on the first device.

The location data 15 may be retransmitted periodically so that if the first user device moves, the policy can be re-evaluated and access to one or more applications can be terminated/restricted if the policy so dictates. Alternatively, the location data may only be re-transmitted if the first user device moves more than a certain distance away from its last recorded location. This can prevent updates occurring too frequently.

FIG. 5 shows a variation of the schematic 400 in FIG. 4. The variation schematic 500 shown in FIG. 5 additionally includes a second server 60, separate from the first server 50. In this case, the policy 55, which is communicated from the first server 50, controls the first user device's access to the second server 60, meaning that communication 65 between the first user device 10 and the second server 60 is effectively controlled and sanctioned by the application management policy 55.

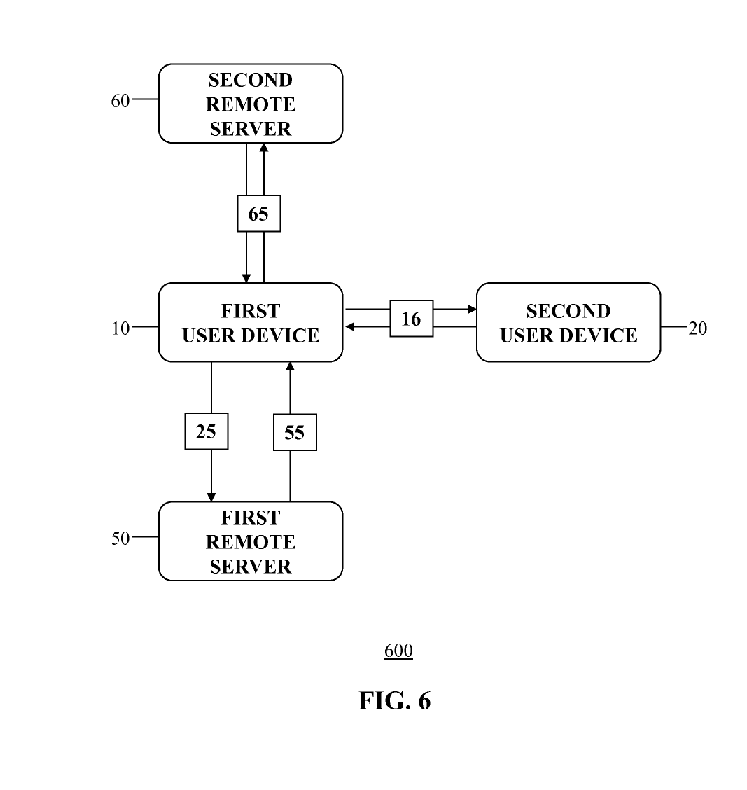

FIG. 6 shows a scenario whereby location data 25 is obtained from the second user device 20, located in close proximity to the first user device 10. As shown there is a 2-way communication link 16 established between the first user device 10 and the second user device 20. The link 16 is preferably an LPRF connection, such as Bluetooth. Other features and elements of the system 600 shown in FIG. 6 are as shown in previous figures.

Throughout this specification, reference has been made to the location of the first user device, determined primarily on the basis of GPS data provided either directly from the first user device or from a second user device whose location serves as a proxy for the location of the first user device. The preferred form of location data is GPS data, but there are occasions when this is not available and still other occasions where its accuracy can be enhanced by supplementing it with other location data, such as that derived from known Wi-Fi APs, mobile telephony base stations and the like. As such, the ones of ordinary skill in the art will understand that any means of providing location data, derived from one or more sources can be utilised by embodiments of the present invention.

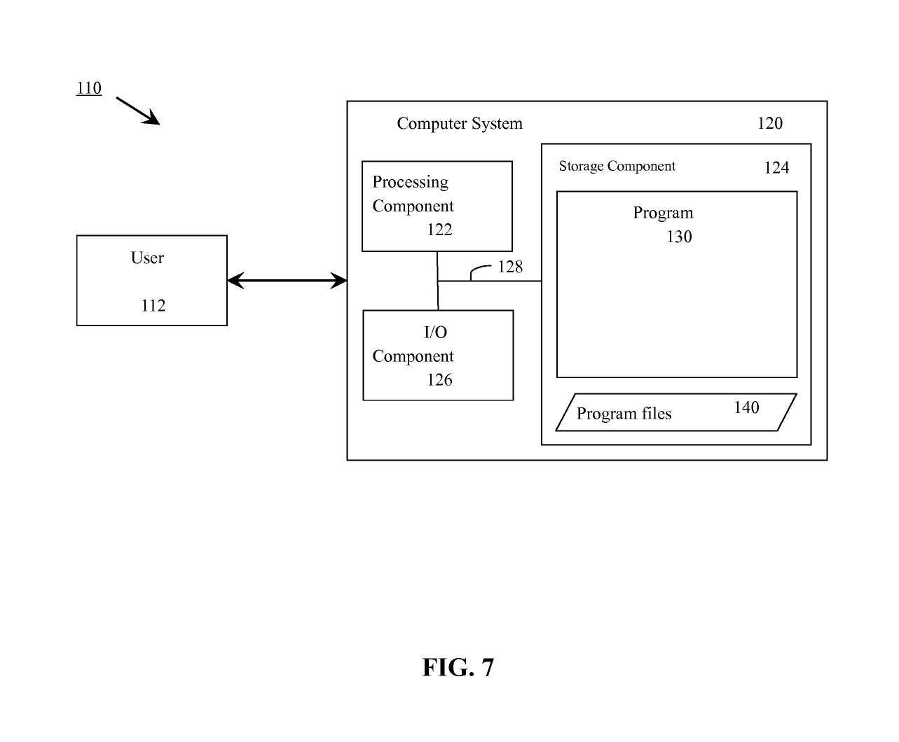

FIG. 7 shows an illustrative environment 110 according to an embodiment of the invention. The ones of ordinary skill in the art will realize and understand that embodiments of the present invention may be implemented using any suitable computer system, and the example system shown in FIG. 7 is exemplary only and provided for the purposes of completeness only. To this extent, environment 110 includes a computer system 120 that can perform a process described herein in order to perform an embodiment of the invention. In particular, computer system 120 is shown including a program 130, which makes computer system 120 operable to implement an embodiment of the invention by performing a process described herein.

Computer system 120 is shown including a processing component 122 (e.g., one or more processors), a storage component 124 (e.g., a storage hierarchy), an input/output (I/O) component 126 (e.g., one or more I/O interfaces and/or devices), and a communications pathway 128. In general, processing component 122 executes program code, such as program 130, which is at least partially fixed in storage component 124. While executing program code, processing component 122 can process data, which can result in reading and/or writing transformed data from/to storage component 124 and/or I/O component 126 for further processing. Pathway 128 provides a communications link between each of the components in computer system 120. I/O component 126 can comprise one or more human I/O devices, which enable a human user 112 to interact with computer system 120 and/or one or more communications devices to enable a system user 112 to communicate with computer system 120 using any type of communications link. To this extent, program 130 can manage a set of interfaces (e.g., graphical user interface(s), application program interface, and/or the like) that enable human and/or system users 112 to interact with program 130. Further, program 130 can manage (e.g., store, retrieve, create, manipulate, organize, present, etc.) the data, such as a plurality of data files 140, using any solution.

In any event, computer system 120 can comprise one or more general purpose computing articles of manufacture (e.g., computing devices) capable of executing program code, such as program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, program 130 can be embodied as any combination of system software and/or application software.

Further, program 130 can be implemented using a set of modules. In this case, a module can enable computer system 120 to perform a set of tasks used by program 130, and can be separately developed and/or implemented apart from other portions of program 130. As used herein, the term “component” means any configuration of hardware, with or without software, which implements the functionality described in conjunction therewith using any solution, while the term “module” means program code that enables a computer system 120 to implement the actions described in conjunction therewith using any solution. When fixed in a storage component 124 of a computer system 120 that includes a processing component 122, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 120.

When computer system 120 comprises multiple computing devices, each computing device can have only a portion of program 130 fixed thereon (e.g., one or more modules). However, it is understood that computer system 120 and program 130 are only representative of various possible equivalent computer systems that may perform a process described herein. To this extent, in other embodiments, the functionality provided by computer system 120 and program 130 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 120 includes multiple computing devices, the computing devices can communicate over any type of communications link. Further, while performing a process described herein, computer system 120 can communicate with one or more other computer systems using any type of communications link. In either case, the communications link can comprise any combination of various types of optical fibre, wired, and/or wireless links; comprise any combination of one or more types of networks; and/or utilize any combination of various types of transmission techniques and protocols.

In any event, computer system 120 can obtain data from files 140 using any solution. For example, computer system 120 can generate and/or be used to generate data files 140, retrieve data from files 140, which may be stored in one or more data stores, receive data from files 140 from another system, and/or the like.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A method of administering an application management policy, the method comprising:
determining, in response to a request made by a first mobile device for access to a service provided over a wireless network, whether the first mobile device is known to a server, wherein the service is provided by one of a plurality of application programs running on the server and wherein the first mobile device is owned and operated by a user;
when the first mobile device is identified to be known to the server, determining whether the first device is capable of providing first location information to the server, wherein the first location information can be used by the server to determine physical location of the first mobile device;
when it is determined that the first mobile device is incapable of providing the first location information, determining whether the first mobile device is in communication with a second mobile device that is capable of providing second location information that can be used to determine physical location of the second mobile device, wherein the second mobile device is owned and operated by the user, wherein the first mobile device and the second mobile device are in close physical proximity such that the second location information can be used as a proxy for the first location information and wherein the first mobile device and the second mobile device are in communication via a communication link;
when it is determined that the first mobile device is in communication with the second mobile device, determining the physical location of the first mobile device using the second location information provided by the second mobile device; and
setting the application management policy, wherein the application management policy is configured to grant or deny the first mobile device access to one or more of the plurality of application programs based on the physical location and identity of the first mobile device.

2. The method of claim 1, further comprising determining the user's identity by authenticating the user's credential, wherein the application management policy is set based further on the identity of the user.

3. The method of claim 1, wherein the communication link includes a physical connection.

4. The method of claim 3, wherein the physical connection includes a data connection cable.

5. The method of claim 1, wherein the communication link includes a low power radio frequency (LPRF) wireless connection.

6. The method of claim 5, wherein the LPRF wireless connection includes a connection that uses a Bluetooth protocol.

7. The method of claim 1, wherein the communication link includes one of a universal serial bus (USB) connection, an Infrared connection or a wireless fidelity (WiFi) connection.

8. The method of claim 1, wherein the first location information is derived from one of: global positioning system (GPS) data, WiFi data or mobile telephony base-station data.

9. The method of claim 1, wherein the physical location of the first mobile device is determined periodically.

10. The method of claim 1, wherein the application management policy is further configured to grant or restrict the first mobile device's access to one or more specific data sets.

11. An apparatus, comprising:
a memory capable of storing data; and
a processor configured for using the data such that the apparatus:
determines, in response to a request made by a first mobile device for access to a service provided over a wireless network, whether the first mobile device is known to the apparatus, wherein the service is provided by one of a plurality of application programs running on the apparatus and wherein the first mobile device is owned and operated by a user;
when the first mobile device is identified to be known to the apparatus, determines whether the first device is capable of providing first location information to the apparatus, wherein the first location information can be used by the apparatus to determine physical location of the first mobile device;
when it is determined that the first mobile device is incapable of providing the first location information, determines whether the first mobile device is in communication with a second mobile device that is capable of providing second location information that can be used to determine physical location of the second mobile device, wherein the second mobile device is owned and operated by the user, wherein the first mobile device and the second mobile device are in close physical proximity such that the second location information can be used as a proxy for the first location information and wherein the first mobile device and the second mobile device are in communication via a communication link;
when it is determined that the first mobile device is in communication with the second mobile device, determines the physical location of the first mobile device using the second location information provided by the second mobile device; and
sets the application management policy, wherein the application management policy is configured to grant or deny the first mobile device access to one or more of the plurality of application programs based on the physical location and identity of the first mobile device.

12. The apparatus of claim 11, wherein the processor is further configured for using the data such that the apparatus determines the user's identity by authenticating the user's credential, wherein the application management policy is set based further on the identity of the user.

13. The apparatus of claim 11, wherein the communication link includes one of a physical connection, a low power radio frequency (LPRF) wireless connection, a USB connection, an infrared connection and a WiFi connection.

14. The apparatus of claim 11, wherein the first location information is derived from one of: GPS data, WiFi data or mobile telephony base-station data.

15. The apparatus of claim 11, wherein the physical location of the first mobile device is determined periodically.

16. The apparatus of claim 11, wherein the physical location of the first mobile device is determined when the user of the first and second mobile devices moves more than a predetermined distance away from a last recorded location.

17. A non-transitory computer-readable medium having executable instructions operable to cause an apparatus to:
determine, in response to a request made by a first mobile device for access to a service provided over a wireless network, whether the first mobile device is known to a server, wherein the service is provided by one of a plurality of application programs running on the server and wherein the first mobile device is owned and operated by a user;
when the first mobile device is identified to be known to the server, determine whether the first device is capable of providing first location information to the server, wherein the first location information can be used by the server to determine physical location of the first mobile device;
when it is determined that the first mobile device is incapable of providing the first location information, determine whether the first mobile device is in communication with a second mobile device that is capable of providing second location information that can be used to determine physical location of the second mobile device, wherein the second mobile device is owned and operated by the user, wherein the first mobile device and the second mobile device are in close physical proximity such that the second location information can be used as a proxy for the first location information and wherein the first mobile device and the second mobile device are in communication via a communication link;
when it is determined that the first mobile device is in communication with the second mobile device, determine the physical location of the first mobile device using the second location information provided by the second mobile device; and
set the application management policy, wherein the application management policy is configured to grant or deny the first mobile device access to one or more of the plurality of application programs based on the physical location and identity of the first mobile device.

18. The computer-readable medium of claim 17, wherein the physical location of the first mobile device includes a known location that is predetermined to be secure and wherein the application management policy is configured to grant the first mobile device access to a set of the plurality of application programs that the user is granted for access when the first mobile device is located in the secure location.

19. The computer-readable medium of claim 17, wherein the application management policy is set at the server and wherein the set application management policy is interpreted at the first mobile device.

20. The computer-readable medium of claim 17, wherein the second mobile device provides the second location information again when the user of the first and second mobile devices moves more than a predetermined distance away from a last recorded location.
